(19) United States
(12) Patent Application Publication
(10) Pub. No.: US 2016/0137808 A1
(43) Pub. Date: May 19, 2016

(54) EPOXY RESIN COMPOSITION FOR ENCAPSULATING SEMICONDUCTOR PACKAGE AND SEMICONDUCTOR PACKAGE ENCAPSULATED USING THE SAME

(71) Applicant: SAMSUNG SDI CO., LTD., Yongin-si (KR)

(72) Inventors: Tae Shin EOM, Uiwang-si (KR); Seung Yong YANG, Uiwang-si (KR); Eun Jung LEE, Uiwang-si (KR); Su Mi IM, Uiwang-si (KR)

(21) Appl. No.: 14/814,271

(22) Filed: Jul. 30, 2015

(30) Foreign Application Priority Data
Nov. 17, 2014 (KR) 10-2014-0160319

(51) Int. Cl. C08K 3/24

(52) U.S. Cl. CPC C08K 3/24

(57) ABSTRACT

Disclosed herein is an epoxy resin composition for encapsulating semiconductor devices, the epoxy resin composition including an epoxy resin, a curing agent, inorganic fillers, and a colorant, the colorant including a hydrate.

### CROSS-REFERENCE TO RELATED APPLICATION

Korean Patent Application No. 10-2014-0160319, filed on Nov. 17, 2014, in the Korean Intellectual Property Office, and entitled: “Epoxy Resin Composition for Encapsulating Semiconductor Package and Semiconductor Package Encapsulated Using the Same,” is incorporated by reference herein in its entirety.

### BACKGROUND

1. Field

Embodiments relate to an epoxy resin composition for encapsulating semiconductor devices, and a semiconductor package encapsulated using the same.

2. Description of the Related Art

In order to protect semiconductor devices from an external environment such as moisture, mechanical shock, and the like, encapsulation of the semiconductor devices using an epoxy resin composition may be used. In addition, a molded epoxy resin encapsulation material may be subjected to surface marking to record information, such as manufacturer, product name, manufacturer's serial number, and the like, on a semiconductor device package.

### SUMMARY

Embodiments are directed to an epoxy resin composition for encapsulating semiconductor devices, the composition including an epoxy resin, a curing agent, an inorganic filler, and a colorant, the colorant including a hydrate.

The hydrate may be represented by Formula 1:

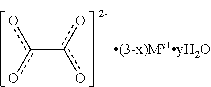

In Formula 1, x may be 1 or 2, y may range from 1 to 10, and M may be a metallic element.

M may include one or more of an alkali metal, an alkali earth metal, a group XIII element, a group XIV element, a group XI element, a group XII element, a group III element, a group IV element, a group V element, a group VI element, a group VII element, a group VIII element, a group IX element, a group X element, or an actinide element.

The hydrate may be present in an amount of about 0.05 wt % to about 15 wt % in the epoxy resin composition.

The colorant may further include carbon black.

The carbon black may be present in an amount of greater than 0 wt % and less than about 0.2 wt % in the epoxy resin composition in terms of solid content.

The carbon black may be present in an amount of greater than 0 wt % and less than about 0.1 wt % in the epoxy resin composition in terms of solid content.

The epoxy resin composition may include about 2 wt % to about 17 wt % of the epoxy resin, about 0.5 wt % to about 13 wt % of the curing agent, about 70 wt % to about 95 wt % of the inorganic filler, and about 0.05 wt % to about 15 wt % of the colorant.

The epoxy resin composition may consist essentially of about 2 wt % to about 17 wt % of the epoxy resin, about 0.5 wt % to about 13 wt % of the curing agent, about 70 wt % to about 95 wt % of the inorganic filler, about 0.05 wt % to about 15 wt % of the colorant, the colorant including carbon black and one or more of cobalt oxalate hydrate or nickel oxalate hydrate, the carbon black being present in an amount of greater than 0 wt % and less than about 0.2 wt % in the epoxy resin composition in terms of solid content, a curing accelerator, and a silicon-containing coupling agent.

The epoxy resin composition may further include one or more of a curing accelerator or a coupling agent.

Embodiments are also directed to a semiconductor package encapsulated using the epoxy resin composition according to an embodiment.

The semiconductor package may have a marking depth of 10 μm to 20 μm, as measured using a laser scanning microscope after laser marking at 1.3 J/pulse using a YAG laser marker (wavelength: 1060 nm, pulse width: 120 μsec), and may have a marking depth of 5 μm to 10 μm, as measured using a laser scanning microscope after laser marking at 0.3 J/pulse using the YAG laser marker.

The semiconductor package may have a marking depth of 10 μm to 20 μm, as measured using a laser scanning microscope after laser marking at 40 W using a fiber laser marker at a wavelength of 1060 nm.

### BRIEF DESCRIPTION OF THE DRAWING

Features will be apparent to those of skill in the art by describing in detail exemplary embodiments with reference to the attached drawing in which:

FIG. 1 illustrates a schematic sectional view of a semiconductor package in accordance with an embodiment.

### DETAILED DESCRIPTION

Example embodiments will now be described more fully hereinafter; however, they may be embodied in different forms and should not be construed as limited to the embodiments set forth herein. Rather, these embodiments are provided so that this disclosure will be thorough and complete, and will fully convey exemplary implementations to those skilled in the art.

Herein, the expression “having excellent low depth markability” means that a certain composition has excellent markability when a marking depth is less than 20 μm.

According to an example embodiment, an epoxy resin composition for encapsulating semiconductor devices includes an epoxy resin, a curing agent, inorganic fillers, and a colorant, wherein the colorant includes a hydrate.

Epoxy Resin

The epoxy resin may be an epoxy resin generally used for encapsulating semiconductor devices. In one embodiment, the epoxy resin may include an epoxy compound containing at least two epoxy groups. Examples of such an epoxy resin may include epoxy resins obtained by epoxidation of a condensate of phenols (or alkyl phenols) and hydroxybenzaldehyde, phenol novolac type epoxy resins, cresol novolac type epoxy resins, polyfunctional epoxy resins, naphthol novolac type epoxy resins, novolac type epoxy resins of bisphenol A/bisphenol F/bisphenol AD, glycidyl ethers of bisphenol A/bisphenol F/bisphenol AD, bishydroxybiphenyl epoxy resins, dicyclopentadiene epoxy resins, and the like.

For example, the epoxy resin may include at least one of an orthocresol novolac type epoxy resin, a biphenyl type epoxy resin, and a phenolaralkyl type epoxy resin.

For example, the phenolaralkyl type epoxy resin may be a phenolaralkyl type epoxy resin containing a biphenyl derivative as represented by Formula 2, and the biphenyl type epoxy resin may be a biphenyl type epoxy resin represented by Formula 3.

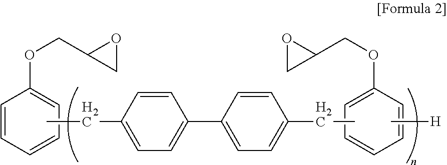

(where n ranges from 1 to 7 on average.)

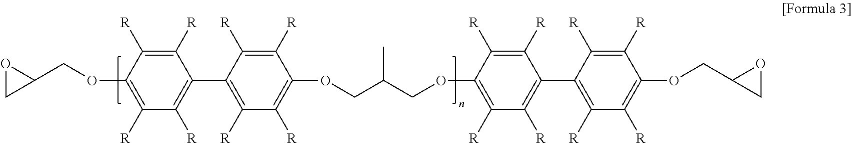

(where each R is independently hydrogen or a C₁ to C₄ alkyl group, and n ranges from 0 to 7 on average.)

For example, R may be a methyl group or an ethyl group, e.g., a methyl group.

Advantageously, the phenol aralkyl type epoxy resin represented by Formula 2 may exhibit excellent moisture absorption, toughness, oxidation resistance, and crack resistance due to a biphenyl structure based on a phenol backbone, and may have low crosslinking density and thus may form a carbon layer (char) when burned at high temperature, thereby securing a certain degree of flame retardancy. In addition, the biphenyl type epoxy resin represented by Formula 3 may advantageously enhance flowability and reliability of the resin composition.

These epoxy resins may be used alone or in combination thereof. In addition, the epoxy resin may be used in the form of adducts, such as a melt master batch, obtained by pre-reaction of the above-described epoxy resins with other additives, such as a curing agent, a curing accelerator, a release agent, a coupling agent, and a stress relief agent. For example, an epoxy resin containing a low amount of chlorine ions, sodium ions, and other ionic impurities may be used in order to improve moisture resistance.

The epoxy resin may be present in an amount of about 2 wt % to about 17 wt %, e.g., about 3 wt % to about 15 wt %, or about 3 wt % to about 12 wt % in the epoxy resin composition. Within this range, the resin composition may exhibit excellent flowability and curing properties.

Curing Agent

The curing agent may be a curing agent typically used in encapsulation of semiconductor devices that contains at least two reactive groups.

Examples of the curing agent may include phenol aralkyl type phenol resins; phenol novolac type phenol resins; Xylok type phenol resins; cresol novolac type phenol resins; naphthol type phenol resins; terpene type phenol resins; polyfunctional phenol resins; dicyclopentadiene phenol resins; novolac type phenol resins prepared from bisphenol A and resol; tris(hydroxyphenyl)methane; multivalent phenol compounds containing dihydroxy biphenyl; acid anhydrides such as maleic anhydride and phthalic anhydride; aromatic amines such as meta phenylene diamine, diamino diphenyl methane, and diamino diphenylsulfone; and the like. For example, the curing agent may include at least one of a phenol novolac type resin, a Xylok type phenol resin, a phenol aralkyl type phenol resin, and a polyfunctional phenol resin.

For example, as the phenol aralkyl type phenol resin, a phenol aralkyl type phenol resin of a novolac structure containing a biphenyl derivative, as represented by Formula 4, may be used; as the Xylok type phenol resin, a Xylok type phenol resin represented by Formula 5 may be used; and as the polyfunctional phenol resin, a polyfunctional phenol resin containing a repeat unit represented by Formula 6 may be used.

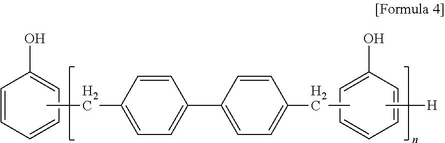

(where n ranges from 1 to 7 on average.)

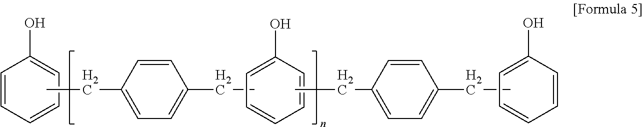

(where n ranges from 0 to 7 on average.)

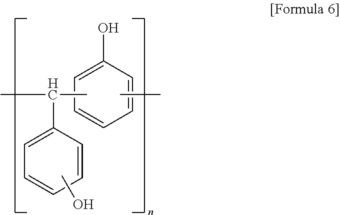

(where n ranges from 1 to 7 on average.)

The phenol aralkyl type phenol resin represented by Formula 4 reacts with the phenol aralkyl type epoxy resin. The resultant may form a carbon layer (char) blocking transmission of surrounding heat and oxygen, thereby providing flame retardancy. The Xylok type phenol resin represented by Formula 5 may advantageously enhance flowability and reliability of the resin composition. The polyfunctional phenol resin represented by Formula 6 may advantageously enhance flexural properties of the epoxy resin composition at high temperature.

These curing agents may be used alone or in combination thereof. For example, the curing agents may be used in the form of adducts, such as a melt master batch, obtained by pre-reacting the above curing agents with other components such as the epoxy resin, a curing accelerator, a release agent, a coupling agent, and a stress relief agent.

The curing agent may be present in an amount of about 0.5 wt % to about 13 wt %, e.g., about 1 wt % to about 10 wt %, or about 2 wt % to about 8 wt % in the epoxy resin composition. Within this range, the resin composition may exhibit excellent flowability and curing properties.

The component ratio of the epoxy resin to the curing agent may be adjusted according to mechanical properties and moisture resistance for a semiconductor package. In one embodiment, the chemical equivalent ratio of the epoxy resin to the curing agent may ranges from about 0.95 to about 2, e.g., from about 1 to about 1.75. Within this range, the resin composition may provide excellent mechanical strength and moisture resistance to the package.

Inorganic Fillers

The inorganic fillers may be used to improve mechanical properties of the epoxy resin composition while reducing stress of the composition. Examples of typical inorganic fillers may include fused silica, crystalline silica, calcium carbonate, magnesium carbonate, alumina, magnesia, clay, talc, calcium silicate, titanium oxide, antimony oxide, glass fibers, and the like.

In one embodiment, fused silica having a low coefficient of linear expansion may be used to reduce stress. Fused silica may refer to amorphous silica having a true specific gravity of 2.3 or less. Fused silica may be produced by melting crystalline silica or may include amorphous silica prepared from various materials. Although the shape and particle diameter of fused silica are not particularly limited, the inorganic fillers may include a fused silica mixture including about 50 wt % to about 99 wt % of spherical fused silica having an average particle diameter of about 5 μm to about 30 μm and about 1 wt % to about 50 wt % of spherical fused silica having an average particle diameter of about 0.001 μm to about 1 μm. Within this range, the resin composition may exhibit excellent flowability. The fused silica mixture may be present in an amount of about 40 wt % to about 100 wt % based on the total weight of the inorganic fillers. Within this range, the resin composition may exhibit excellent properties in terms of flowability and package moldability. In addition, the maximum particle diameter of the fused silica may be adjusted to any one of about 45 μm, about 55 μm, and about 75 μm depending upon desired use of the resin composition. The spherical fused silica may include conductive carbon as a foreign substance on a surface thereof. In this case, however, it is important to select a material having less polar foreign substances intruding thereinto.

The amount of the inorganic fillers may vary depending upon required properties such as moldability, low stress characteristics, and strength at high temperature. In one example, the inorganic fillers may be present in an amount of about 70 wt % to about 95 wt %, specifically about 75 wt % to about 92 wt % in the epoxy resin composition for encapsulating semiconductor devices.

Colorant

In one embodiment, the colorant may include a hydrate, wherein the hydrate may be represented by Formula 1:

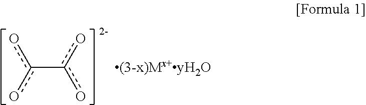

(where x is 1 or 2, y ranges from 1 to 10, and M is a metallic element).

The hydrate may provide higher visibility and markability than non-hydrate colorants to the composition. During laser marking, the hydrate may change its color and may be burned away as a temperature increases.

In one embodiment, the metal may include at least one of alkali metals, alkali earth metals, group XIII elements, group XIV elements, group XI elements, group XII elements, group III elements, group IV elements, group V elements, group VI elements, group VII elements, group VIII elements, group IX elements, group X elements, and actinide elements.

The alkali metals may include at least one of lithium (Li), sodium (Na), potassium (K), rubidium (Rb), cesium (Cs), and francium (Fr); the alkali earth metals may include at least one of calcium (Ca), strontium (Sr), barium (Ba), and radium (Ra); and the group XIII elements may include at least one of aluminum (Al), gallium (Ga), indium (In), and thallium (Tl).

The group XIV elements may include at least one of tin (Sn) and lead (Pb); the group XI elements may include at least one of copper (Cu), silver (Ag), and gold (Au); group XII elements may include at least one of zinc (Zn), cadmium (Cd), and mercury (Hg); the group III elements may include at least one of scandium (Sc), yttrium (Y), and elements having atomic numbers of 57 to 71; the group IV elements may include at least one of titanium (Ti), zirconium (Zr), and hafnium (Hf); the group V elements may include at least one of vanadium (V), niobium (Nb), and tantalum (Ta); the group VI elements may include at least one of chromium (Cr), molybdenum (Mo), and tungsten (W); the group VII elements may include at least one of manganese (Mn), technetium (Tc), and rhenium (Re); the group VIII elements may include at least one of iron (Fe), ruthenium (Ru), and osmium (Os); the group IX elements may include at least one of cobalt (Co), rhodium (Rh), and iridium (Ir); the group X elements may include at least one of nickel (Ni), palladium (Pd), and platinum (Pt); and the actinide elements may include at least one of elements with atomic numbers of 89 to 103. For example, the metal may include at least one of cobalt, nickel, copper, aluminum, calcium, iron, zinc, tin, lithium, strontium, manganese and barium. For example, the hydrate may comprise one of metal oxalate hydrates. For example, the hydrate may include one or more of cobalt oxalate hydrate, nickel oxalate hydrate, copper oxalate hydrate, aluminum oxalate hydrate, calcium oxalate hydrate, iron oxalate hydrate, zinc oxalate hydrate, tin oxalate hydrate, lithium oxalate hydrate, strontium oxalate hydrate, manganese oxalate hydrate or barium oxalate hydrate.

A value of y may vary depending upon the kind of hydrate. For example, y ranges from 1 to 10, specifically from 1 to 6, more specifically from 1 to 4. Within this range, the colorant may exhibit excellent coloring properties and provide good laser markability to the composition.

A semiconductor device encapsulated by an epoxy resin not including the hydrate as a colorant requires a temperature of about 1,000° C. or higher in laser marking, whereas a semiconductor device encapsulated by an epoxy resin including the hydrate as a colorant may be marked even at a temperature of less than about 1,000° C., for example, at about 200° C. to about 500° C., and thus has excellent low depth markability. Having excellent low depth markability means that a marking process may be performed using a low power laser, which is economical and prevents chip defects due to excessive heat during laser marking.

In one embodiment, the hydrate may be present in an amount of about 0.05 wt % to about 15 wt %, e.g., about 0.05 wt % to about 13 wt %, or about 0.05 wt % to about 10 wt % in the epoxy resin composition. In one embodiment, the hydrate may be present in the epoxy resin composition in an amount of about 0.05 wt %, 0.1 wt %, 0.3 wt %, 0.5 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, 10 wt %, 10.5 wt %, 11 wt %, 11.5 wt %, 12 wt %, 12.5 wt %, 13 wt %, 13.5 wt %, 14 wt %, 14.5 wt %, or 15 wt %. In addition, the hydrate may be present in an amount of from one of the above values to one of the above values. Within this range, the resin composition provides excellent markability even at a low depth in marking using a low power laser.

In another embodiment, the colorant may further include carbon black. When the colorant includes carbon black, the carbon black may be present, in terms of solid content, in an amount of less than about 0.2 wt %, specifically about 0 wt % to about 0.1 wt %. Within this range, the carbon black may not affect laser markability provided by the hydrate while preventing occurrence of soot during laser marking.

The colorant may be present in an amount of about 0.05 wt % to about 15 wt %, e.g., about 0.05 wt % to about 13 wt %, or about 0.05 wt % to about 10 wt % in the epoxy resin composition. Within this range, it may be possible to avoid incomplete marking, deterioration in markability due to occurrence of soot during marking, and degradation in electrical insulation of the resin composition.

In one embodiment, the epoxy resin composition may further include at least one of a curing accelerator and a coupling agent.

Curing Accelerator

The curing accelerator may serve to promote reaction between the epoxy resin and the curing agent. Examples of the curing accelerator may include tertiary amines, organometallic compounds, organophosphorus compounds, imidazole compounds, boron compounds, and the like. Examples of the tertiary amines may include benzyldimethylamine, triethanolamine, triethylenediamine, dimethylaminoethanol, tri(dimethylaminomethyl)phenol, 2-2-(dimethylaminomethyl)phenol, 2,4,6-tris(diaminomethyl)phenol, and salts of tri-2-ethylhexanoic acid.

Examples of the organometallic compounds may include chromium acetylacetonate, zinc acetylacetonate, and nickel acetylacetonate. Examples of the organophosphorus compounds may include tris(4-methoxy)phosphine, tetrabutylphosphonium bromide, tetraphenylphosphonium bromide, phenylphosphine, diphenylphosphine, triphenylphosphine, triphenylphosphine triphenylborane, and triphenylphosphine-1,4-benzoquinone adducts. Examples of the imidazole compounds may include 2-methylimidazole, 2-phenylimidazole, 2-aminoimidazole, 2-methyl-1-vinylimidazole, 2-ethyl-4-methylimidazole, and 2-heptadecylimidazole. Examples of the boron compounds may include tetraphenylphosphonium-tetraphenylborate, triphenylphosphine tetraphenylborate, tetraphenylboron salts, trifluoroborane-n-hexylamine, trifluoroborane monoethylamine, tetrafluoroborane triethylamine, and tetrafluoroborane amine. In addition, 1,5-diazabicyclo[4.3.0]non-5-ene (DBN), 1,8-diazabicyclo[5.4.0]undec-7-ene (DBU), and phenol novolac resin salts may be used.

For example, as the curing accelerator, organophosphorus compounds, boron compounds, amine compounds, and imidazole compounds may be used alone or in combination thereof. Further, the curing accelerator may be used in the form of adducts obtained by pre-reacting these compounds with the epoxy resin or the curing agent.

The curing accelerator may be present in an amount of about 0.01 wt % to about 2 wt %, e.g., about 0.02 wt % to about 1.5 wt %, or about 0.05 wt % to about 1 wt %, based on the total weight of the epoxy resin composition. Within this range, the curing accelerator may promote curing of the composition while securing good degree of curing.

Coupling Agent

The epoxy resin composition for encapsulating semiconductor devices may further include a coupling agent.

The coupling agent may be a silane coupling agent that reacts between the epoxy resin and the inorganic fillers, and may enhance strength of an interface between the epoxy resin and the inorganic fillers, and may include epoxysilane, aminosilane, ureidosilane, mercaptosilane, and the like. These coupling agents may be used alone or in combination thereof.

The coupling agent may be present in an amount of about 0.01 wt % to about 5 wt %, e.g., about 0.05 wt % to about 3 wt %, or about 0.1 wt % to about 2 wt %, based on the total weight of the epoxy resin composition. Within this range, the coupling agent may provide excellent adhesion and interfacial strength.

In addition, the epoxy resin composition according to the present example embodiment may further include a release agent such as higher fatty acids, higher fatty acid metal salts, and ester wax; a stress relief agent such as modified silicone oil, silicone powder, and silicone resins; and antioxidants such as tetrakis[methylene-3-(3,5-di-tertbutyl-4-hydroxyphenyl)propionate]methane.

As a general method for preparing the epoxy resin composition using the aforementioned components, there is a method wherein predetermined amounts of the components are mixed uniformly and sufficiently using a Henschel mixer or a Lödige mixer, followed by melt kneading using a roll mill or a kneader, and then cooling and pulverizing, thereby obtaining a final powder product.

As a method for encapsulating semiconductor devices using the epoxy resin composition, pressure transfer molding may be typically used. However, injection molding or casting may also be employed. By the aforementioned methods, the epoxy resin composition may be applied to a copper lead frame (for example, a silver plated copper lead frame), a nickel alloy lead frame, a lead frame obtained by pre-plating a material including nickel and palladium onto the lead frame and then plating at least one of silver (Ag) and gold (Au) thereon, a PCB, and the like, to encapsulate the semiconductor devices, thereby fabricating a semiconductor package (apparatus).

Semiconductor Package

In accordance with an embodiment, a semiconductor package may include, e.g., a substrate; a semiconductor device mounted on the substrate; a connecting portion electrically connecting the semiconductor device and the substrate; and a molding portion encapsulating the semiconductor device and the connecting portion.

The molding portion may be formed of or prepared from the epoxy resin composition for encapsulating a semiconductor device as set forth above.

The semiconductor device may be provided in plural and mounted on the substrate via a die adhesive film.

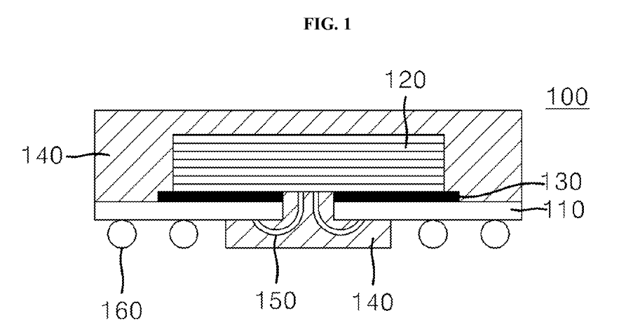

FIG. 1 illustrates a schematic sectional view of a semiconductor package 100 in accordance with an embodiment. Referring to FIG. 1, the semiconductor package 100 may be a board-on-chip (BOC) type semiconductor package, and may include a substrate 110, a die adhesive film 130 placed on the substrate 110, a semiconductor device 120 on the substrate 110 and attached to the substrate 110 through the die adhesive film 130, a connecting portion 150, e.g., a bonding wire, for mutual electric connection of the semiconductor device 120 and the substrate 110, a molding portion 140 encapsulating the semiconductor device 120 and the connecting portion 150, and protecting a mount structure including the substrate 110, the semiconductor device 120 mounted on the substrate 110, and the connecting portion 150.

A plurality of solder balls 160 for electric connection of the semiconductor device 120 to an outer circuit (not shown) may be formed on a surface of the substrate facing a mount surface of the substrate with the semiconductor device 120 mounted thereon.

The molding portion 140 may be formed on the substrate 110 to completely cover the semiconductor device 120 and the connecting portion 150.

The molding portion 140 may include or may be prepared from the epoxy resin composition for encapsulating a semiconductor device. In an implementation, the die adhesive film 130 may be a silicon-based die adhesive film.

In one embodiment, the semiconductor package may have a marking depth of 10 μm to 20 μm, as measured using a laser scanning microscope after laser marking at 1.3 J/pulse using a YAG laser marker (wavelength: 1060 nm, pulse width: 120 μsec), and have a marking depth of 5 μm to 10 μm, as measured using a laser scanning microscope after laser marking at 0.3 J/pulse using the YAG laser marker.

In another embodiment, the semiconductor package may have a marking depth of 10 μm to 20 μm, as measured using a laser scanning microscope after laser marking at 40 W using a fiber laser marker (wavelength: 1060 nm).

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES

(A) Epoxy Resin

(a1) Ortho cresol novolac type epoxy resin: EOCN-1020-55 (Nippon Kayaku Co., Ltd.) was used.

(a2) Biphenyl type epoxy resin: YX-4000H (Japan Epoxy Resin Co., Ltd.) was used.

(a3) Phenol aralkyl type epoxy resin: NC-3000 (Nippon Kayaku Co., Ltd.) was used.

(B) Curing Agent

(b1) Phenol novolac resin: HF-1 (Meiwa Kasei Industries, Ltd.) was used.

(b2) Xylok type phenol resin: KPH-F3065 (Kolon Chemical Co., Ltd.) was used.

(b3) Phenol aralkyl type phenol resin: MEH-7851SS (Meiwa Kasei Industries, Ltd.) was used.

(C) Curing accelerator: Triphenylphosphine (TPP) (Hokko Chemical Co., Ltd.) was used.

(D) Inorganic filler: A mixture of spherical fused silica having an average particle diameter of 20 μm and spherical fused silica having an average particle diameter of 0.5 μm mixed in a ratio of 9:1 was used.

(E) Coupling Agent

(e1) Epoxysilane: S-510 (Chisso Corporation) was used.

(e2) Mercaptosilane: KBM-803 (Shin-Etsu Silicone Co., Ltd.) was used.

(F) Colorant

(f1) Cobalt oxalate hydrate: NR-2900 (TERADA CHEMISCHE FABRIC) as represented by Formula 1-1:

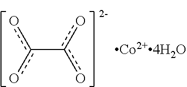

(f2) Carbon black: MA-600B (Mitsubishi Chemical Co., Ltd.) was used.

(G) Release agent: Carnauba wax was used.

(H) Stress relief agent: E-601 (Toray Silicone Co., Ltd.) was used.

### Examples 1 to 5 and Comparative Examples 1 to 5

The components were weighed in amounts as listed in Table 1 and uniformly mixed at 25° C. to 30° C. for 30 minutes using a Henschel mixer (KSM-22, Keum Sung Machinery Co., Ltd.), followed by melt kneading at a temperature of up to 110° C. for 30 minutes using a continuous kneader and then cooling to a temperature of 10° C. to 15° C. and pulverizing, thereby preparing an epoxy resin composition for encapsulating semiconductor devices.

TABLE 1
(unit: wt %)

| | | Example | | | | | Comparative Example | | | | |
|---|---|---|---|---|---|---|---|---|---|---|---|
| | | 1 | 2 | 3 | 4 | 5 | 1 | 2 | 3 | 4 | 5 |
| (A) | (a1) | 5 | 0 | 4 | 3.4 | 8.6 | 4.5 | 4.5 | 3.5 | 3.95 | 9.2 |
| | (a2) | 2 | 2.75 | 2.6 | 0 | 0 | 1.8 | 2 | 3 | 0 | 0 |
| | (a3) | 0 | 3.5 | 0 | 2.7 | 0 | 0 | 0 | 0 | 2 | 0 |
| (B) | (b1) | 5.5 | 0 | 2.1 | 2.5 | 7.2 | 3.3 | 3.5 | 3.7 | 3.1 | 7 |
| | (b2) | 0 | 4.6 | 1.7 | 1.8 | 0 | 1.9 | 1.5 | 1.5 | 1.8 | 0 |
| | (b3) | 0 | 1 | 0 | 0 | 0 | 0 | 0 | 0 | 0 | 0 |
| (C) | | 0.2 | 0.2 | 0.1 | 0.1 | 0.3 | 0.1 | 0.1 | 0.2 | 0.1 | 0.4 |
| (D) | | 78 | 82 | 87 | 84 | 80 | 87 | 87 | 87 | 88 | 82 |
| (E) | (e1) | 0.15 | 0.35 | 0.3 | 0.3 | 0.2 | 0.2 | 0.3 | 0.15 | 0.2 | 0.35 |
| | (e2) | 0.35 | 0.15 | 0.2 | 0.2 | 0.3 | 0.3 | 0.2 | 0.35 | 0.3 | 0.15 |
| (F) | (f1) | 8.3 | 5.15 | 1.1 | 4.15 | 2.2 | — | — | — | — | — |
| | (f2) | — | — | 0.1 | 0.05 | 0.03 | 0.2 | 0.2 | 0.3 | 0.15 | 0.2 |

| | | | | | | | | | | |
|---|---|---|---|---|---|---|---|---|---|---|
| (G) | 0.2 | 0.3 | 0.3 | 0.3 | 0.4 | 0.3 | 0.4 | 0.3 | 0.2 | 0.2 |
| (H) | 0.3 | 0 | 0.5 | 0.5 | 0.5 | 0.4 | 0.3 | 0 | 0.2 | 0.5 |
| Total | 100 | 100 | 100 | 100 | 100 | 100 | 100 | 100 | 100 | 100 |

Each of the epoxy resin compositions for encapsulating semiconductor devices prepared in the Examples and Comparative Examples was evaluated as to the following properties. For each package, each of the epoxy resin compositions was molded at 175° C. for 120 seconds using a multi-plunger system (MPS) molding machine and subjected to post-curing at 175° C. for 6 hours, followed by laser marking.

Property Evaluation

(1) YAG laser marker: Pulse type, EO-Tech Co., Ltd.

wavelength: 1060 nm/pulse width: 120 μsec/laser beam output: 1.3 J/pulse or 0.3 J/pulse

(2) Fiber laser marker: EO-Tech Co., Ltd.

wavelength: 1060 nm/laser output: 40 W or 10 W

Each of the epoxy resin compositions was subjected to molding, thereby obtaining an encapsulated semiconductor package. Each of the molded articles was subjected to laser marking, and an appearance of the resulting article was observed with an optical microscope and the naked eye to identify laser markability and amount of soot. In addition, marking depth (μm) was measured using a laser scanning microscope. Results are shown in Table 2.

The molded article was rated as o when exhibiting excellent laser markability and having negligible amount of soot; the molded article was rated as A when exhibiting relatively poor laser markability and having slightly unclear markings; and the molded article was rated as x when exhibiting undesirable laser markability.

TABLE 2

| | | Kind of laser | | | | | | | |
|---|---|---|---|---|---|---|---|---|---|
| | | YAG laser | | | | Fiber laser | | | |
| | | Output: 1.3 J/pulse | | Output: 0.3 J/pulse | | Output: 40 W | | Output: 10 W | |
| | | | Depth | | Depth | | Depth | | Depth |
| | Package | Markability | (μm) | Markability | (μm) | Markability | (μm) | Markability | (μm) |
| Example 1 | BOC | ∘ | 20 | ∘ | 10 | ∘ | 15 | ∘ | 8 |
| Example 2 | BOC | ∘ | 15 | ∘ | 8 | ∘ | 10 | ∘ | 7 |
| Example 3 | BOC | ∘ | 15 | ∘ | 10 | ∘ | 10 | ∘ | 5 |
| Example 4 | TSOP | ∘ | 15 | ∘ | 7 | ∘ | 12 | ∘ | 7 |
| Example 5 | FBGA | ∘ | 18 | ∘ | 7 | ∘ | 10 | ∘ | 7 |
| Comp. | BOC | Δ | 30 | x | 15 | Δ | 25 | x | 10 |
| Example 1 | | | | | | | | | |
| Comp. | BOC | Δ | 35 | x | 15 | Δ | 30 | x | 10 |
| Example 2 | | | | | | | | | |
| Comp. | BOC | Δ | 40 | x | 20 | ∘ | 35 | x | 15 |
| Example 3 | | | | | | | | | |
| Comp. | BOC | x | 30 | x | 15 | Δ | 25 | x | 10 |
| Example 4 | | | | | | | | | |
| Comp. | BOC | Δ | 35 | x | 15 | Δ | 30 | x | 10 |
| Example 5 | | | | | | | | | |

BOC: Board On Chip
TSOP: Thin Small Outline Package
FBGA: Fine pitch Ball Grid Array

As shown in Table 2, it can be seen that the epoxy resin compositions of Examples 1 to 5 exhibited good laser markability in use of both a YAG laser and a fiber laser, and exhibited excellent low depth markability even when marking was performed to a depth of 20 μm or less at 0.3 J/pulse or 10 W.

On the contrary, it can be seen that the epoxy resin compositions of Comparative Examples not including the hydrate exhibited undesirable laser markability or exhibited large amounts of soot.

By way of summation and review, a marking method may include marking the surface of the molded epoxy resin encapsulation material with marking inks such as UV curable inks. However, this method is time consuming and costly, e.g., due to curing and cleaning processes.

A method of marking a surface of an encapsulating material of a semiconductor package may include using a laser beam. Advantageously, this method may allow rapid processing, semi-permanent marking, and low cost.

For general laser marking, carbon black may be used as a colorant. However, when laser power is reduced to decrease costs for a marking process, marking contrast may be deteriorated. Further, in a map type section molded substrate package, such as fine pitch ball grid array (FBGA), board on chip (BOC), and the like, marking contrast may also be deteriorated due to flexural properties of the package. Further, it may not be possible to address such difficulties simply by controlling the amount and grain size distribution of carbon black, and thus desired contrast may not be obtained. For example, when an insufficient amount of carbon black is added to a resin composition, the composition may not sufficiently absorb thermal energy generated during marking, thereby causing incomplete marking Conversely, when an excess of carbon black is used, the resin composition may provide low electrical insulation and exhibit increased generation of soot during marking, which may cause contamination of a marking site and make it difficult to identify marked characters.

As described above, embodiments may provide an epoxy resin composition for encapsulating semiconductor devices that is capable of realizing excellent markability, and a semiconductor package encapsulated using the same.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An epoxy resin composition for encapsulating semiconductor devices, the composition comprising: an epoxy resin, a curing agent, an inorganic filler, and a colorant, the colorant including a hydrate.

2. The epoxy resin composition as claimed in claim 1, wherein the hydrate is represented by Formula 1: 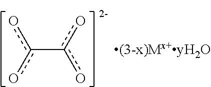
wherein, in Formula 1, x is 1 or 2, y ranges from 1 to 10, and M is a metallic element.

3. The epoxy resin composition as claimed in claim 2, wherein M includes one or more of an alkali metal, an alkali earth metal, a group XIII element, a group XIV element, a group XI element, a group XII element, a group III element, a group IV element, a group V element, a group VI element, a group VII element, a group VIII element, a group IX element, a group X element, or an actinide element.

4. The epoxy resin composition as claimed in claim 1, wherein the hydrate is present in an amount of about 0.05 wt % to about 15 wt % in the epoxy resin composition.

5. The epoxy resin composition as claimed in claim 1, wherein the colorant further includes carbon black.

6. The epoxy resin composition as claimed in claim 5, wherein the carbon black is present in an amount of greater than 0 wt % and less than about 0.2 wt % in the epoxy resin composition in terms of solid content.

7. The epoxy resin composition as claimed in claim 5, wherein the carbon black is present in an amount of greater than 0 wt % and less than about 0.1 wt % in the epoxy resin composition in terms of solid content.

8. The epoxy resin composition as claimed in claim 5, comprising: about 2 wt % to about 17 wt % of the epoxy resin, about 0.5 wt % to about 13 wt % of the curing agent, about 70 wt % to about 95 wt % of the inorganic filler, and about 0.05 wt % to about 15 wt % of the colorant.

9. The epoxy resin composition as claimed in claim 8, consisting essentially of:
about 2 wt % to about 17 wt % of the epoxy resin,
about 0.5 wt % to about 13 wt % of the curing agent,
about 70 wt % to about 95 wt % of the inorganic filler,
about 0.05 wt % to about 15 wt % of the colorant, the colorant including carbon black and one or more of cobalt oxalate hydrate or nickel oxalate hydrate, the carbon black being present in an amount of greater than 0 wt % and less than about 0.2 wt % in the epoxy resin composition in terms of solid content,
a curing accelerator, and
a silicon-containing coupling agent.

10. The epoxy resin composition as claimed in claim 1, further comprising one or more of a curing accelerator or a coupling agent.

11. A semiconductor package encapsulated using the epoxy resin composition as claimed in claim 1.

12. The semiconductor package as claimed in claim 11, wherein the semiconductor package has a marking depth of 10 μm to 20 μm, as measured using a laser scanning microscope after laser marking at 1.3 J/pulse using a YAG laser marker (wavelength: 1060 nm, pulse width: 120 μsec), and has a marking depth of 5 μm to 10 μm, as measured using a laser scanning microscope after laser marking at 0.3 J/pulse using the YAG laser marker.

13. The semiconductor package as claimed in claim 11, wherein the semiconductor package has a marking depth of 10 μm to 20 μm, as measured using a laser scanning microscope after laser marking at 40 W using a fiber laser marker at a wavelength of 1060 nm.
